(19) United States
(12) Patent Application Publication
(10) Pub. No.: US 2004/0090075 A1
(43) Pub. Date: May 13, 2004

(54) Remotely powered chuck

(76) Inventor: Robert Bushman, Elmhurst, IL (US)

Correspondence Address: Gregory B. Beggs, Law Offices of Gregory B. Beggs, 5100 Fairview Avenue, Downers Grove, IL, 60515, US

(21) Appl. No.: 10/291,720

(22) Filed: Nov. 12, 2002

(51) Int. Cl. B25J 15/00

(52) U.S. Cl. 294/119.3

(57) ABSTRACT

A grasping member which may be operated from a distance to inflate it and thereby engage an object, such as a light bulb, in order to unscrew the bulb from its socket, is disclosed. The member is an inflatable chuck, which may be mounted on the end of a long pole. In one embodiment, the walls of the chuck form a pocket for a light bulb located in a high ceiling or other hard-to-reach place. When inflated, the walls of the chuck enfold and grasp the bulb to permit an operator holding the pole to turn it and unscrew the bulb. Another embodiment of the chuck is also disclosed in which the walls of the chuck expand outwardly instead of inwardly when the chuck is inflated.

This invention relates to a grasping member which may be operated from a distance to inflate it and thereby engage an object, such as a light bulb, in order to unscrew the bulb from its socket. More particularly, it relates to an inflatable chuck mounted on the end of a long pole. The walls of the chuck form a pocket for a light bulb located in a high ceiling or other hard-to-reach place. When inflated, the walls of the chuck enfold and grasp the bulb to permit an operator holding the pole to turn it and unscrew the bulb.

### BACKGROUND OF THE INVENTION

Pneumatic tools located on the end of a pole are well known, as are pneumatically restrained telescoping segments of poles holding conventional tools. An example of the former is U.S. Pat. No. 5,853,208, and an example of the latter is U.S. Pat. No. 4,719,978. Non-pneumatic poles and tools for engaging light bulbs in remote places are also known, as illustrated in U.S. Pat. No. 4,719,826. In the '826 patent, a yoke which operates as a spring is located on the end of a long pole and connects two flexible arms which are adapted to be placed on either side of a light bulb. The arms can then be pulled together by means of a lanyard so that they engage the light bulb between them. Somewhat similarly, tulip shaped clusters of fingers formed of spring materials such as curved flat strips of metal have been mounted on the ends of long poles for reaching light bulbs in high places.

Whenever the parts to be handled are small, or ungainly, or relatively fragile, the available prior art equipment is less than satisfactory. The available equipment is often too large, or rough, and the workpieces are likely to be dropped or broken. The large lanyard-operated arms often fail to grip securely, and the plastic materials with which they are frequently coated often slip. The wide, flat arms and the tulip-shaped grippers seldom fit the objects which they are intended to handle. Such equipment is often too bulky, heavy and unmanageable when the objects to be manipulated require long poles. And the poles themselves are quite heavy when they are sized for lifting the tools.

The present invention is designed to overcome these and other problems, such as the need for expensive scaffolding when several small light bulbs must be changed in a high ceiling or on a highly-hung chandelier.

### SUMMARY OF THE INVENTION

The present invention is an inflatable chuck which may be fixed to the end of a long, light weight pole. The chuck has a tubular inflatable member with inner and outer elastic walls surrounding a tubular passageway. The passageway has a first, open end and a plug at the second end closing the tubular passageway at that point. There is a tubular cavity between the inner and outer elastic walls, and there is an inlet to the cavity near the plug. A non-elastic member is disposed against one of the elastic walls which bars expansion of that wall during inflation of the tubular cavity. A gas or fluid supply line extends from a source of such fluid into the tubular cavity through the inlet so that the gas or fluid may be supplied to or withdrawn from the tubular cavity. A clamp holds the elastic walls of the tubular inflatable member against the plug and seals them against the plug while the supply line transmits the gas or fluid into or from the tubular cavity. The fluid is under any suitable amount of pressure as it is introduced into or withdrawn from the cavity and thus regulates the amount of inflation of the cavity and expansion of the cavity walls.

From the foregoing, and from what follows, it will be apparent that the present invention solves numerous problems which operators have had in attempting to use tools which are situated at the end of a long rod or pole.

It is one of the objects of the present invention to provide a light weight chuck for grasping and securely manipulating small items such as small light bulbs located high above an operator.

It is a further object of this invention to provide a chuck having flexible, inflatable walls for engaging and conforming to most of the surface area of an item being handled in the chuck.

It is a further object of this invention to provide a chuck having flexible, inflatable and soft-surfaced engaging surfaces for handling fragile items in the chuck.

It is a further object of this invention to provide a chuck having flexible, inflatable walls with item engaging surfaces which are urged against most of the surface area of an item being handled in the chuck by a sensitively regulated pressurized gas or fluid.

It is a further object of this invention to provide a chuck which may be mounted on the end of a long light weight pole that is easily manipulated by an operator in order to access hard-to-reach places.

It is also an object of this invention to provide a form of chuck having flexible, inflatable walls which can be expanded inside an aperture in an item to be moved by the chuck in order to engage the surfaces of the item which surround and form the aperture.

Other objects and features of this invention will be apparent to those skilled in the art of making pneumatically operated tools disposed on the ends of poles from an examination of the following detailed description of preferred embodiments of this invention and of the accompanying drawings.

### BRIEF DESCRIPTION OF THE DRAWINGS

FIG. 1 is a perspective view of the chuck of the present invention connected to the end of a pole (shown in phantom) and holding a light bulb;

FIG. 2 is an elevational view of the chuck assembly of FIG. 1 showing the light bulb disengaged from the chuck;

FIG. 3 is a sectional view of the chuck shown in FIG. 2 taken along the line 3-3 in FIG. 2;

FIG. 4 is a sectional view of the chuck shown in FIG. 2 taken along the line 4-4 in FIG. 2;

FIG. 5 is an enlarged sectional view of the chuck shown in FIG. 2 taken along the line 5-5 in FIG. 2;

FIG. 6 is an exploded view showing the elements in of the chuck shown in FIG. 2 in perspective, with two of the elements being shown also in phantom at an intermediate stage of being assembled with the other elements of the chuck; and

FIG. 7 is a sectional view of an alternative embodiment of the chuck shown in FIGS. 1 through 6 taken along an identical line as the line 5-5 in FIG. 2.

### DESCRIPTION OF THE PREFERRED EMBODIMENTS

The preferred embodiments of this invention shown in the accompanying drawings will now be described, it being understood that the preferred forms are illustrative and that the invention described herein is embodied in the claims which are appended hereto.

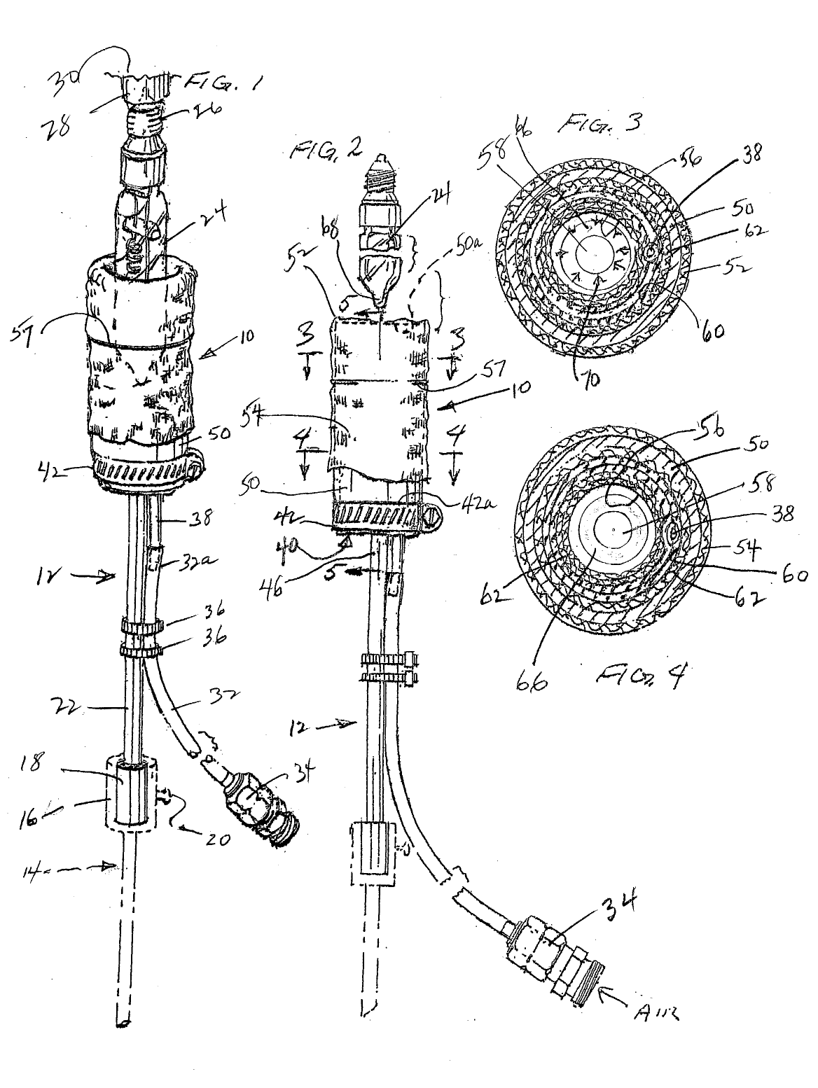

As shown in FIG. 1, the chuck assembly 10 of the present invention includes a pole-end connector 12 extending between the chuck assembly and the tip end 14 of a lightweight pole. In the embodiment illustrated in FIG. 1, the tip end 14 of the pole includes a cup-shaped receptor means 16. A mating connector 18 which is matched to the receptor 16 is received in the receptor and fixed there by a fastening means such as thumbscrew 20. A rod 22, preferably made of a light, strong material such as aluminum, is attached to the connector 18 and supports the chuck assembly 10, mounting it securely on the tip-end 14 of the lightweight pole. Other suitable connecting means for attaching the chuck assembly 10 to the pole may be selected, and the combination just described is only intended to be illustrative.

The chuck assembly 10, in the illustrated embodiment of this invention shown in FIG. 1, is sized and arranged to be placed over and grasp a light bulb, such as light bulb 24, which has burned out in use and needs to be changed. The light bulb is used as an example of an item which the chuck assembly might engage because it is small and fragile, i.e., hard to grasp and easy to break, needing to be carefully but firmly handled. Other similar bulb-type objects can be noted, i.e., fragile and small metal or wooden pins, or plastic parts, which are located in hard-to-reach places and need to be picked out and moved. Light bulb 24 is normally screwed, by means of its threaded base 26, into a socket 28, the latter being mounted into a ceiling 30 which is located in an auditorium or other such congregational or cathedral environment high above the head of an operator who needs to change the burned out bulb in such a lofty place. It is especially desirable to avoid having to bring in a scaffolding structure, which is quite expensive, to change such burned out bulbs in this type of an environment.

The chuck assembly 10 is inflatable. Compressed air or a similarly pressurized fluid may be pumped into the assembly 10 through a long, light weight tube 32 attached by means of a coupling 34 to a compressor (not shown). Tube 32 may be tied to rod 22 with any suitable ties 36 which are preferably located near the junction of rod 22 and the chuck assembly 10. Tube 32 is thus stabilized near the chuck assembly so that it will not pull away from its connection to the chuck assembly, even when the length of the tube is many feet and extends way above the floor where an operator would be standing to a ceiling where the light bulb socket 28 is located. A compressed air lead-in tube connector, such as the tube connector segment 38, may be utilized so that the segment 38 may be firmly grasped in the chuck assembly 10, and an end portion 32a of the tube 32, just above the ties 36, may be slipped onto the segment 38 and maintained there securely by the ties. The advantage of such a connection is that the tube 32 can be readily joined to the chuck assembly without any need for threading it in a sealing manner into the chuck assembly 10 each time the equipment is used. Alternatively, however, the tube 32 and the segment 38 may be made as just one unit if one prefers.

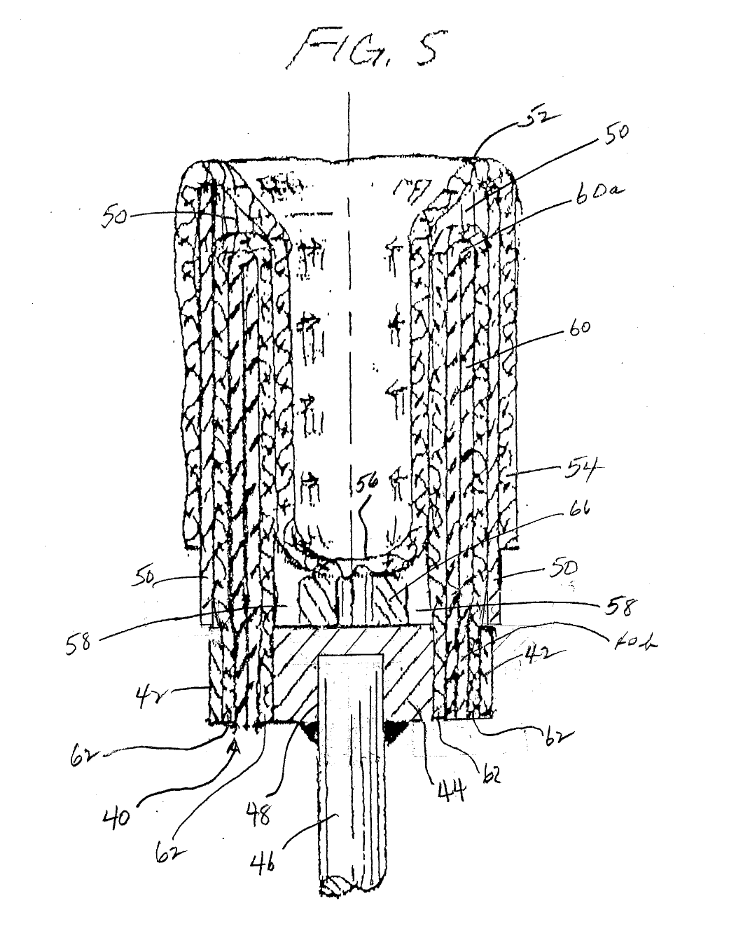

The chuck assembly 10 is shown in further detail in FIGS. 2-6. In summary, the assembly includes a bladder shaped like a sleeve jacketed in a relatively non-flexible cylindrically shaped sheath and forming a central aperture inside the walls of the bladder and sheath. When jacketed in this manner, the bladder can expand only in one direction, namely, inwardly. If the chuck assembly, before it is inflated, is placed over an object (such as a light bulb) which fits at least substantially into the central aperture, and the chuck assembly is inflated, the inner walls of the bladder facing into the central aperture swell toward the center of the aperture and firmly engage the portion of the object disposed there.

More particularly, in the elevational view shown in FIG. 2, the chuck assembly 10 has a lower end portion 40 which is clamped together with a clamp such as hose clamp 42. Inside the chuck assembly 10, a plug 44 is mounted on the upper end 46 of the pole-end connector so that when clamp 42 is tightened, the lower end portion 40 of the chuck assembly is firmly closed against the plug 44. If a firm, air pressure tight closure is not achieved by simply tightening clamp 42, it may be desirable to use an adhesive, such as a gel form of the adhesive known under the trademark “Super Glue,” to obtain a strong enough closure.

When plug 44 is mounted on the end of the pole-end connector, it may be frictionally engaged on the upper end 46 of connector 12, as illustrated at the junction 48 (see FIG. 5), so that the plug 44 does not slip or rotate about the connector's upper end 46. A similar non-rotatable junction may be made in the assembly at this point by using a set screw (not shown) or even an adhesive.

A non-elastic sheath 50 forms an outer layer about the chuck assembly 10 except for a sock 52 which has an open end cuff portion 54 overlying the outside of the sheath 50 and a closed end toe portion 56 disposed inside and lining a central aperture 58 formed inside the chuck assembly 10. The sock 52 acts as a guide, when the chuck assembly is placed over a light bulb, to direct the bulb into the center of assembly 10. An elastic tie 57 binds the sock 52 in place on the sheath and maintains the toe portion 56 inside the central aperture. As illustrated in FIGS. 2 and 5, the sheath 50 preferably extends from an edge 42a of the clamp 42 to its outer end 50a to enclose the rest of the clutch assembly 10.

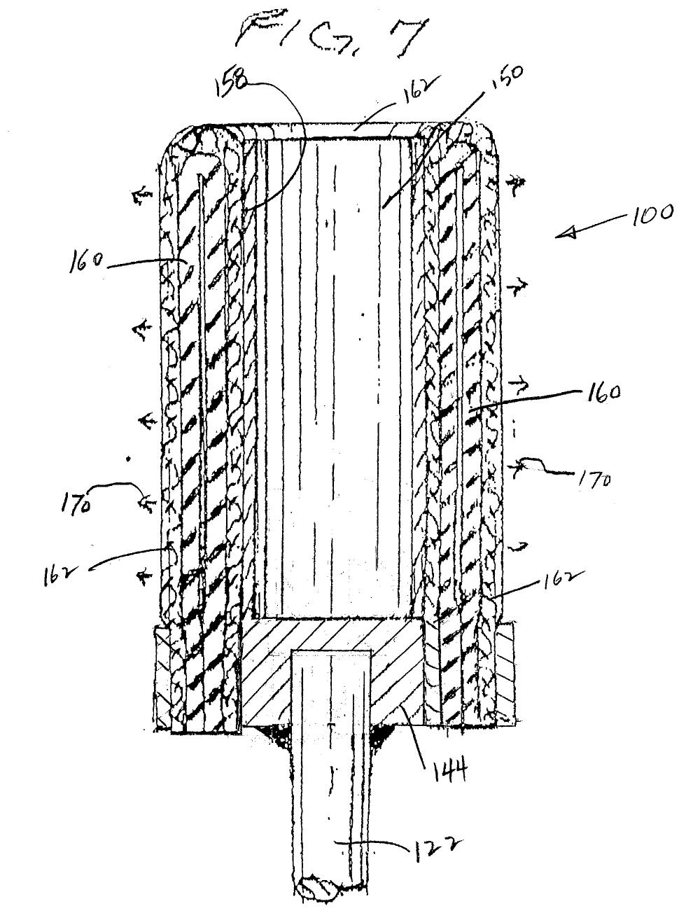

The clutch assembly 10 also includes an inflatable bladder member 60 which is substantially disposed inside of and encircled by sheath 50. The bladder member 60 is a flexible walled envelope which has a closed end portion 60a and separate end portions 60b which, when pressed together close and seal the bladder member 60. As shown in FIG. 5, the closeable end portions 60b are clamped closed when clamp 42 is tightened and squeezes them together against plug 44. It has been found that using the “Super Glue” adhesive gel assures a sealing engagement. One way of forming the bladder member just described is illustrated in phantom in FIG. 6., namely, to begin with a tube 60 of flexible, inflatable material, such as a length of rubber tubing, and then fold one end portion 60b, or the other end portion 60b, over on the remainder of tube 60 until the end portions 60b meet. The end portions 60b may then be clamped against each other to form a closed end of the bladder member 60. Means for inflating the bladder member 60 are provided by inserting connector 38 between the ends 60b before they are clamped against the plug 44. After the end portions 60b are clamped together, compressed air or a similar fluid may be pumped through connector 38 into bladder member 60 to accomplish the inflation.

Other means of forming and inflating the bladder member 60 may be used, such as forming a sealed bladder without utilizing a clamp and introducing air into it through a gasket formed in one of the walls of such a bladder.

It is also desirable to enclose the bladder member 60 in a fabric sleeve 62 to permit the bladder member to expand and contract freely within the sleeve but to limit its expansion to that set by the sleeve's flexibility. Also, the sleeve 62 provides additional cushioning, which complements sock 52, for handling fragile items, and it provides a nestable base layer for enfolding such fragile items as the bladder member is inflated.

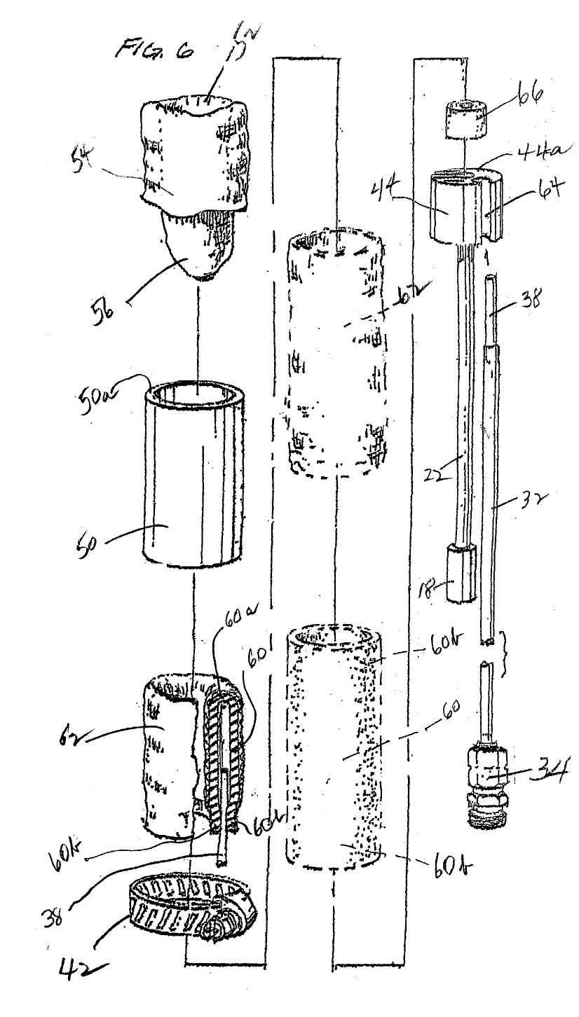

FIG. 6 illustrates a desirable configuration for plug 44. When the tube connector segment 38 is positioned between the bladder closeable end portions 60b so that it extends into the interior of the bladder member 60, tightening clamp 42 causes the closeable end portions 60b to clamp down on tube segment 38 Segment 38 may also be secured there with a gel type adhesive. Plug 44 is provided with a notch 64 adjacent its periphery for the extra thickness of the tube segment 38 and adjacent layers of the bladder member 60 and sleeve 62 to fit into. The tube segment 38 is preferably made of a pliable tubing, and when the clamp 42 is tightened to assure a seal of the closeable end portions 60b of the bladder member, the tube segment 38 is pressed toward notch 64 and usually assumes a rather oval cross-sectional shape adjacent the plug 44. Such an oval cross-section of the tube segment 38 is shown in FIG. 4.

Most light bulbs have pointed or dome-shaped glass bulb portions opposite their screw or dagger type bases. They can be centrally positioned very easily inside the chuck assembly 10 in order to insert them into their sockets by placing a rubber washer 66 or similar soft doughnut-shaped element on the upper surface 44a of the plug 44 which faces the interior central aperture 58 formed by the bladder member 60 and fabric sleeve 62. The tip end 68 of the light bulb 24 (assuming that light bulb 24 is a good bulb, not a burned out one) can be centered in chuck assembly 10 in the toe end 56 of sock 52 by pushing the tip end 68 into a nesting engagement with the washer 66. Similarly, if light bulb 24 were a burned out bulb to be removed from a socket, the chuck assembly 10 could be centrally oriented to the bulb, even high above an operator's head, simply by pressing the chuck assembly 10 onto the bulb 24 and permitting the tip of the bulb to seek the hole in the center of the washer.

However, the walls of the chuck are flexible and cushioned by both air pressure and soft fabric. Such a construction permits slight deviations from head-on alignment with a bulb, thus permitting engagement of the bulb without breaking it if the chuck is somewhat off center from the bulb during engagement.

Using the chuck assembly 10 just described on the end of a long, light weight pole is an effective way of reaching and disconnecting light bulbs in lofty ceiling fixtures, such as socket 28 in ceiling 30, without any need for expensive scaffolding construction and greatly shortening the time needed to replace burned out light bulbs. An operator merely connects a rod, such as rod 22 on which a chuck assembly 10 is mounted, to the tip of a long pole 14, connects the coupling 34 in the air supply line 32 to a source of air under pressure such as a compressor, and lifts the chuck assembly and air supply line to the ceiling. There the chuck assembly 10 is nested around the bulb to be changed, and air under pressure is supplied to pump up the bladder member 60. When the pressure is sufficient, usually about 20 psi, the chuck assembly 10 grasps the bulb to be removed firmly but softly enough to avoid breaking it. The operator then twists the pole to turn the bulb and remove it from its socket. The pole is thereafter lowered, and the spent light bulb removed from the chuck assembly and discarded.

The chuck assembly 10 is also quite useful in putting a new light bulb into a vacant socket. The chuck assembly 10 and pole 14 are readied in the same manner as they were for removing a spent bulb from a high ceiling as above described. In order to hold a new bulb properly so that it can be installed without danger of breaking it, the chuck assembly 10 needs to be correctly inflated. Small bulbs are quite fragile, especially at the point where the glass enclosure which holds the filament joins the bulb's base. Since the glass enclosure is used as a handle when the base of a bulb is twisted into place in a socket, when a new bulb is being installed using the present invention, care must be taken when the glass holding the filament is turned. The most desirable grasp by the chuck assembly 10 on a new light bulb is one which holds the bulb securely but also permits an operator, who holds the end of the pole far away from the chuck assembly, the handle end of the pole, to twist the bulb into its socket without breaking it. An operator at the handle end of the pole cannot feel, through the chuck assembly and the length of the pole, when a bulb becomes securely seated. Therefore, the firmness of the chuck assembly's grasp on the bulb must also permit the grip to slip when the bulb stops turning.

The air pressure in the inflatable bladder member 60 can be regulated which in turn regulates the firmness of the chuck assembly's grasp on a light bulb. As shown particularly in FIG. 3, the non-elastic sheath 50 limits expansion of the inflatable bladder member 60 in an outward direction when the bladder member is being inflated. Substantially all of the expansion is inwardly into the central aperture 58 of the chuck assembly 10, as shown by the arrows 70. When the bladder member is inflated in this manner, it has been found that an air pressure of about 12 psi will hold a light bulb securely by its glass head in the chuck assembly as the bulb is lifted up to an empty socket, and it has also been found that that degree of air pressure will accomplish slippage of the chuck assembly grip on the glass head of the bulb whenever the base of the bulb becomes firmly seated in the socket. Notably, however, the 12 psi measurement was also affected by the construction of the bulbs being tested, and it should be expected that the amount of air pressure which should be used with different light bulb constructions to accomplish grip slippage needs to be observed from one type of bulb to another.

FIG. 7 illustrates an alternative chuck assembly 100 utilizing elements which are identical to those comprising the chuck assembly 10, except that the elements in the chuck assembly shown in FIG. 7 are arranged so that the inflatable bladder member 160, on being inflated, expands outwardly in the directions indicated by the arrows 170, not inwardly into the central aperture 158 formed in the chuck assembly 100. This alternative embodiment may be use to reach into an opening in an item and then engage it by enlarging the bladder member with compressed air until the bladder member, or its jacket, engages the walls of the opening in a frictional grasp. As shown, a non-elastic sheath 150 is arranged inside a central aperture 158 formed by the inflatable bladder member 160. The sheath is bottomed on a plug 144 attached to a rod 122. The inflatable bladder member 160 and the fabric sleeve 162 are clamped onto the plug 144 by a clamp member 142. Inflation of the bladder member 160 is accomplished in the same manner as previously explained through an air pressure line (not shown) leading into the bladder member 160.

When inflation is initiated, the non-elastic sheath 150 limits expansion of the bladder member 160 in the direction of the central aperture 158, and accordingly the outer wall of the bladder member expands mostly in the outward directions indicated by the arrows 170. When the chuck assembly 100 is placed inside an aperture in an object to be grasped, expansion of the bladder member 160 will bring the outside surfaces 162 of the bladder member into a frictional grip with the boundary walls of the aperture inside the object, and the object can be manipulated with the chuck assembly while being held in this manner.

It is evident from the foregoing disclosure that even though particular forms of the invention have been illustrated and described, still, various modifications can be made without departing from the true spirit and scope of the invention. Accordingly, no limitations on the invention are intended by the foregoing description of its preferred embodiments, and its scope is covered by the following claims.

I claim:

1. An inflatable chuck comprising
a tubular inflatable member including
inner and outer elastic walls surrounding a tubular passageway and forming
a first open end of the passageway,
a second end of the passageway adapted to receive a plug
closing the passageway at the second end,
a tubular cavity between the inner and outer elastic walls, and
an annular inlet to the tubular cavity adjacent the second end of the passageway,
a plug disposed in the second end of the passageway surrounded by the annular inlet formed by the elastic walls,
a non-elastic member in contact with one of the elastic walls barring expansion of that wall past the non-elastic member during inflation of the tubular cavity,
a tubular gas supply line having an end disposed in the annular inlet for supplying or withdrawing gas from the tubular cavity, and
a clamp disposed about the elastic walls adjacent the second end of the tubular member and the plug urging the elastic walls adjacent the annular inlet into sealing engagement with themselves and against the plug as the gas supply line transmits gas into or out of the tubular cavity regulating the amount of inflation thereof.

2. The chuck of claim 1 in which the non-elastic member is disposed outside of the tubular passageway.

3. The chuck of claim 1 in which the non-elastic member is disposed inside of the tubular passageway.

4. The chuck of claim 2 in which the elastic walls of the inflatable member are covered by a first fabric sleeve having an end portion between the non-elastic member and the outer elastic wall and a second end portion disposed upon the inner elastic wall inside the tubular passageway.

5. The chuck of claim 4 in which at least one of the end portions of the fabric sleeve is held by the clamp against a portion of an elastic wall of the inflatable member adjacent the annular inlet.

6. The chuck of claim 4 in which a cushion member is disposed on the plug facing the inside of the tubular passageway.

7. The chuck of claim 4 in which a second fabric sleeve having an open end portion and a closed end portion covers the first sleeve and the non-elastic member, the second fabric sleeve open end portion being arranged outside the tubular passageway over the non-elastic member, and the second fabric sleeve closed end portion being arranged inside the tubular passageway adjacent the plug.
